(19) United States
(12) Patent Application Publication
(10) Pub. No.: US 2009/0269442 A1
(43) Pub. Date: Oct. 29, 2009

(54) PET FOOD AND METHOD FOR PRODUCING THE SAME

(76) Inventors: Guangquan XIONG, Wuhan (CN); Wei CHENG, Wuhan (CN); Lixiu YE, Wuhan (CN); Ming ZHOU, Wuhan (CN); Xin DU, Wuhan (CN); Ruotai LIN, Wuhan (CN); Shujing XUE, Wuhan (CN); Shengrong GENG, Wuhan (CN); Xin LI, Wuhan (CN)

Correspondence Address: MATTHIAS SCHOLL, 14781 MEMORIAL DRIVE, SUITE 1319, HOUSTON, TX, 77079, US

(21) Appl. No.: 12/431,079

(22) Filed: Apr. 28, 2009

(30) Foreign Application Priority Data
Apr. 29, 2008 (CN) 200810047502.4

(51) Int. Cl. A23K 1/16; A23L 1/303; A23K 1/00; A23K 1/10; A23K 1/14; A23K 1/175

(52) U.S. Cl. 426/73; 426/72; 426/635

(57) ABSTRACT

Pet food, including processed low-value freshwater fish, corn or sweet potato, soybean or double-low rapeseed, vitamin complex, trace elements, and beef flavor or chicken flavor. The weight ratio of the processed low-value freshwater fish to the corn or the sweet potato and to the soybean or the double-low rapeseed is 1:(1.2-2):1, the beef flavor or the chicken flavor accounts for 0.1% of the sum of the by-products, the corn or the sweet potato, and the soybean or the double-low rapeseed by weight, the vitamin complex accounts for 0.1% of the sum of the processed low-value freshwater fish, the corn or the sweet potato, and the soybean or the double-low rapeseed by weight, and the trace elements accounts for 0.2% of the sum of the processed low-value freshwater fish, the corn or the sweet potato, and the soybean or the double-low rapeseed by weight.

### CROSS-REFERENCE TO RELATED APPLICATIONS

Pursuant to 35 U.S.C. § 119 and the Paris Convention Treaty, this application claims the benefit of Chinese Patent Application No. 200810047502.4 filed on Apr. 29, 2008, the contents of which are incorporated herein by reference.

### BACKGROUND OF THE INVENTION

1. Field of the Invention

The invention relates to a food and a method for producing the same, and more particularly to a pet food and a method for producing the same.

2. Description of the Related Art

Conventionally, pet food is made of meat as well as added vitamins and minerals. However, some un-neglectable problems with the existing pet food are that the pet food consumes human food and is comparatively expensive.

### SUMMARY OF THE INVENTION

In view of the above-described problems, it is an objective of the invention to provide a pet food that does not consume human food and features low cost.

It is another objective of the invention to provide a method for producing a pet food that does not consume human food and features low cost.

To achieve the above objective, in accordance with one aspect of the invention, there is provided a pet food, including by-products processed by low-value freshwater fishes, corn or sweet potato, soybean or double-low rapeseed (low erucic acid and low glucosinolate rapeseed), vitamin complex, trace elements, and beef flavor or chicken flavor, wherein a weight ratio of the by-products to the corn or the sweet potato and to the soybean or the double-low rapeseed is 1:(1.2-2):1, the beef flavor or the chicken flavor accounts for 0.1% of the sum of the by-products, the corn or the sweet potato, and the soybean or the double-low rapeseed by weight, the vitamin complex accounts for 0.1% of the sum of the by-products, the corn or the sweet potato, and the soybean or the double-low rapeseed by weight, and the trace elements accounts for 0.2% of the sum of the by-products, the corn or the sweet potato, and the soybean or the double-low rapeseed by weight.

In certain classes of this embodiment, the by-products of the low-value freshwater fishes include fish heads, fish bones, fish skin, fish scale, and fish viscera.

In certain classes of this embodiment, the vitamin complex include VA, VD, VE, VB, VB2, VB3, VB5, VB6, VB12, folic acid, and choline.

In certain classes of this embodiment, the trace elements include Ca, P, K, S, mg, Fe, Cu, Mn, Zn, I, and Se.

In certain classes of this embodiment, contents of the vitamin complex per Kg include VA 5500000 IU, VD 521000 IU, VE 57000 IU, VB1 1100 mg, VB2 2300 mg, VB3 10500 mg, VB5 11900 mg, VB6 2000 mg, folic acid 230 mg, VB12 50 mg, and choline 123000 mg.

In certain classes of this embodiment, contents of the trace elements per Kg include Ca 160 g, P 150 g, K 180 g, S 60 g, mg 10 g, Fe 43000 mg, Cu 370 mg, Mn 2800 mg, Zn 64000 mg, I 900 mg, and Se 60 mg.

In accordance with another aspect of the invention, there is provide a method for producing a pet food, including steps of: providing by-products processed by low-value freshwater fishes, corn or sweet potato, and soybean or double-low rapeseed with a weight ratio of 1:(1.2-2):1, and adding vitamin complex, beef flavor or chicken flavor, and trace elements respectively accounting for 0.1%, 0.1% and 0.2% of the sum of the by-products, the corn or the sweet potato, and the soybean or the double-low rapeseed by weight; processing the by-products, the corn or the sweet potato, the soybean or the double-low rapeseed, the vitamin complex, the beef flavor or chicken flavor, and the trace elements via a twin-screw extruder at a first zone temperature of 166-184° C., a second zone temperature of 131-159° C., a third zone temperature of 70-82° C., a pressure of −1.23-2.3 MPa, a screw speed of 30-50 rpm and a feed rate of 4-17 rpm; vacuum packaging the by-products, the corn or the sweet potato, the soybean or the double-low rapeseed, the vitamin complex, the beef flavor or chicken flavor, and the trace elements from the twin-screw extruder, and irradiating them at approximately 4 kGy until amount of bacteria is less than 300/g.

In certain classes of this embodiment, the first zone temperature is 176° C., the second zone temperature is 135° C., and the third zone temperature is 76° C.

In certain classes of this embodiment, the pressure is −1.23 MPa.

In certain classes of this embodiment, the screw speed is 50 rpm.

In certain classes of this embodiment, the feed speed is 17 rpm.

Advantages of the invention are: 1) making full use of by-products processed by low-value freshwater fishes; 2) reducing production cost of the pet food.

### DETAILED DESCRIPTION OF THE EMBODIMENTS

A pet food of the invention is composed of by-products processed by low-value freshwater fishes, corn or sweet potato, soybean or double-low rapeseed (low erucic acid and low glucosinolate rapeseed), vitamin complex, trace elements, and beef flavor or chicken flavor. A weight ratio of the by-products to the corn or the sweet potato and to the soybean or the double-low rapeseed is 1:(1.2-2):1, the beef flavor or the chicken flavor accounts for 0.1% of the sum of the by-products, the corn or the sweet potato, and the soybean or the double-low rapeseed by weight, the vitamin complex accounts for 0.1% of the sum of the by-products, the corn or the sweet potato, and the soybean or the double-low rapeseed by weight, and the trace elements accounts for 0.2% of the sum of the by-products, the corn or the sweet potato, and the soybean or the double-low rapeseed by weight.

In this embodiment, the by-products of the low-value freshwater fishes include fish heads, fish bones, fish skin, fish scale, and fish viscera, the vitamin complex include VA, VD, VE, VB, VB2, VB3, VB5, VB6, VB12, folic acid, and choline, the trace elements include Ca, P, K, S, mg, Fe, Cu, Mn, Zn, I, and Se, and contents of the vitamin complex per Kg include VA 5500000 IU, VD 521000 IU, VE 57000 IU, VB1 1100 mg, VB2 2300 mg, VB3 10500 mg, VB5 11900 mg, VB6 2000 mg, folic acid 230 mg, VB12 50 mg, and choline 123000 mg.

A method for producing a pet food of the invention includes steps of: providing by-products processed by low-value freshwater fishes, corn or sweet potato, and soybean or double-low rapeseed with a weight ratio of 1:(1.2-2):1, and adding vitamin complex, beef flavor or chicken flavor, and trace elements respectively accounting for 0.1%, 0.1% and 0.2% of the sum of the by-products, the corn or the sweet potato, and the soybean or the double-low rapeseed by weight; processing the by-products, the corn or the sweet potato, the soybean or the double-low rapeseed, the vitamin complex, the beef flavor or chicken flavor, and the trace elements via a twin-screw extruder at a first zone temperature of 166-184° C., a second zone temperature of 131-159° C., a third zone temperature of 70-82° C., a pressure of −1.23-2.3 MPa, a screw speed of 30-50 rpm and a feed rate of 4-17 rpm; vacuum packaging the by-products, the corn or the sweet potato, the soybean or the double-low rapeseed, the vitamin complex, the beef flavor or chicken flavor, and the trace elements from the twin-screw extruder, and irradiating them at approximately 4 kGy until amount of bacteria is less than 300/g.

### Example 1

By-products processed by low-value freshwater fishes, corn, and soybean with a weight ratio of 1:2:1 is provided. Then, vitamin complex, beef flavor, and trace elements respectively accounting for 0.1%, 0.1% and 0.2% of the sum of the by-products, the corn, and the soybean by weight are added. The above-mentioned mixture is processed via an expanded low-temperature micro-processing technology to determine contents of protein, fat, moisture, vitamin, and trace elements of the pet dog food and nutrition index thereof.

Table 1 illustrates comparison between the measured nutrition index of the pet dog food of the invention and standard nutrition index presented by Association of American Feed Control Officials (AAFCO). As can be seen from Table 1, nutrition index of the pet dogfood of the invention meet the nutrition standard.

TABLE 1

| Nutriment | Unit | AAFCO index | Measured index |
|---|---|---|---|
| Protein | % | 18.0 | 18.1 |
| Fat | % | 5.0 | 5.0 |
| Ca | % | 0.6 | 0.66 |
| P | % | 0.5 | 0.52 |
| K | % | 0.6 | 0.6 |
| S | % | 0.06 | 0.06 |
| mg | % | 0.04 | 0.1 |
| Fe | mg/Kg | 80 | 86 |
| Cu | mg/Kg | 7.3 | 7.4 |
| Mn | mg/Kg | 5.0 | 5.5 |
| Zn | mg/Kg | 120 | 128 |
| I | mg/Kg | 1.5 | 1.8 |
| Se | mg/Kg | 0.11 | 0.12 |
| VA | IU/Kg | 5000 | 5500 |
| VD | IU/Kg | 500 | 521 |
| VE | IU/Kg | 50 | 57 |
| VB1 | mg/Kg | 1.0 | 1.1 |
| VB2 | mg/Kg | 2.2 | 2.3 |
| VB3 | mg/Kg | 10.0 | 10.5 |
| VB5 | mg/Kg | 11.4 | 11.9 |
| VB6 | mg/Kg | 1.0 | 2.0 |
| Folic acid | mg/Kg | 0.18 | 0.23 |
| VB12 | mg/Kg | 0.022 | 0.05 |
| Choline | mg/Kg | 1200 | 1230 |

### Example 2

By-products processed by low-value freshwater fishes, sweet potato, and double-low rapeseed with a weight ratio of 1:2:1 is provided. Then, vitamin complex, beef flavor and trace elements respectively accounting for 0.1%, 0.1% and 0.2% of the sum of the by-products, the sweet potato, and the double-low rapeseed by weight are added. The above-mentioned mixture is processed via the expanded low-temperature micro-processing technology as the first embodiment to determine contents of protein, fat, moisture, vitamin, and trace elements of the pet food and nutrition index thereof. The measurement result is the same as Example 1.

### Example 3

By-products processed by low-value freshwater fishes, sweet potato, and double-low rapeseed with a weight ratio of 1:1.2:1 is provided. Then, vitamin complex, chicken flavor and trace elements respectively accounting for 0.1%, 0.1% and 0.2% of the sum of the by-products, the sweet potato, and the double-low rapeseed by weight are added. The above-mentioned mixture is processed via the expanded low-temperature micro-processing technology as the first embodiment to determine contents of protein, fat, moisture, vitamin, and trace elements of the pet cat food and nutrition index thereof.

Table 2 illustrates comparison between the nutrition index of the pet cat food of the invention and standard nutrition index presented by AAFCO. It can be seen from Table 2 that the nutrition index of the pet cat food of the invention meet the nutrition standard.

TABLE 2

| Nutriment | Unit | AAFCO index | Measured index |
|---|---|---|---|
| Protein | % | 26.0 | 26.1 |
| Fat | % | 9.0 | 9.0 |
| Ca | % | 0.6 | 0.65 |
| P | % | 0.5 | 0.51 |
| K | % | 0.6 | 0.66 |
| S | % | 0.2 | 0.2 |
| mg | % | 0.04 | 0.05 |
| Fe | mg/Kg | 80 | 88 |
| Cu | mg/Kg | 15.0 | 15.1 |
| Mn | mg/Kg | 7.5 | 7.7 |
| Zn | mg/Kg | 75 | 78 |
| I | mg/Kg | 0.35 | 0.35 |
| Se | mg/Kg | 0.1 | 0.1 |
| VA | IU/Kg | 5000 | 5100 |
| VD | IU/Kg | 500 | 508 |
| VE | IU/Kg | 30 | 31 |
| VB1 | mg/Kg | 5.0 | 5.1 |
| VB2 | mg/Kg | 4.0 | 4.3 |
| VB3 | mg/Kg | 5.0 | 5.9 |
| VB5 | mg/Kg | 60.0 | 61.0 |
| VB6 | mg/Kg | 4.0 | 4.4 |
| Folic acid | mg/Kg | 0.8 | 0.9 |
| VB12 | mg/Kg | 0.002 | 0.05 |
| Choline | mg/Kg | 1200 | 1210 |

### Example 4

Based on the components in Example 1, test is conducted at different feed speeds, screw speeds, temperature, and pressure to determine effects of various factors on the quality of the pet food. Test results are listed in Table 3 as follows.

TABLE 3

| | | | | | | | General |
|---|---|---|---|---|---|---|---|
| | | | | | | | score |
| | Temperature | | | | Screw | Feed | score (the |
| Serial | First | Second | Third | Pressure | speed | speed | full mark |
| number | zone | zone | zone | Mpa | rpm | rpm | is 100) |
| 1 | 172 | 155 | 82 | / | 30 | 4 | 60 |
| 2 | 166 | 156 | 77 | 2.3 | 30 | 4 | 75 |
| 3 | 168 | 158 | 70 | −1.05 | 30 | 4 | 80 |
| 4 | 170 | 159 | 79 | −2.07 | 25 | 4 | 80 |
| 5 | 179 | 151 | 79 | −1.23 | 50 | 4 | 85 |
| 6 | 184 | 150 | 78 | −1.22 | 50 | 10 | 88 |
| 7 | 178 | 142 | 77 | −1.18 | 50 | 15 | 90 |
| 8 | 176 | 135 | 76 | −1.23 | 50 | 17 | 95 |
| 9 | 175 | 131 | 77 | −1.11 | 50 | 17 | 90 |

It can be seen from Table 3 that the preferred processing condition is: the first zone temperature is 176° C.; the second zone temperature is 135° C.; the third zone temperature is 76° C.; the pressure is −1.23 MPa; the screw speed is 50 rpm; and the feed speed is 17 rpm. Pet food prepared under the condition features good appearance, crisp taste, and easy storage.

### Example 5

Pet food produced in Example 1 is vacuum-packed. Then test is conducted with different irradiation sterilization dose. Test results are listed in Table 4 as follows.

TABLE 4

| | Irradiation sterilization | Total number of bacteria |
|---|---|---|
| Serial number | dose | (number/g) |
| 1 | 0 | 35000 |
| 2 | 2 | 2000 |
| 3 | 4 | 100 |
| 4 | 6 | 10 |
| 5 | 8 | 0 |

It can be seen from Table 4 that the number of bacteria of the pet food is up to 100/g after being irradiated at 4 kGy. The value is less than that presented by the Standard of Export Pet Food (300/g). The shelf-life of the pet food of the invention is 12 months.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A pet food, comprising:
processed low-value freshwater fish;
corn or sweet potato;
soybean or double-low rapeseed;
vitamin complex;
trace elements; and
beef flavor or chicken flavor;
wherein,
the weight ratio of said by-products to said corn or said sweet potato and to said soybean or said double-low rapeseed is 1:(1.2-2):1;
said beef flavor or said chicken flavor accounts for 0.1% of the sum of said by-products, said corn or said sweet potato, and said soybean or said double-low rapeseed by weight;
said vitamin complex accounts for 0.1% of the sum of said by-products, said corn or said sweet potato, and said soybean or said double-low rapeseed by weight; and
said trace elements accounts for 0.2% of the sum of said by-products, said corn or said sweet potato, and said soybean or said double-low rapeseed by weight.

2. The pet food of claim 1, wherein said by-products of the low-value freshwater fishes comprise fish heads; fish bones; fish skin; fish scale, and fish viscera.

3. The pet food of claim 1, wherein said vitamin complex comprise VA, VD, VE, VB, VB2, VB3, VB5, VB6, VB12, folic acid, and choline.

4. The pet food of claim 1, wherein said trace elements comprise Ca, P, K, S, mg, Fe, Cu, Mn, Zn, I, and Se.

5. The pet food of claim 3, wherein contents of said vitamin complex per Kg comprise VA 5500000 IU, VD 521000 IU, VE 57000 IU, VB1 1100 mg, VB2 2300 mg, VB3 10500 mg, VB5 11900 mg, VB6 2000 mg, folic acid 230 mg, VB12 50 mg, and choline 123000 mg.

6. The pet food of claim 4, wherein contents of said trace elements per Kg comprise Ca 160 g, P 150 g, K 180 g, S 60 g, mg 10 g, Fe 43000 mg, Cu 370 mg, Mn 2800 mg, Zn 64000 mg, I 900 mg, and Se 60 mg.

7. A method for producing a pet food, comprising steps of:
providing processed low-value freshwater fish, corn or sweet potato, and soybean or double-low rapeseed with a weight ratio of 1:(1.2-2):1, and adding vitamin complex, beef flavor or chicken flavor, and trace elements respectively accounting for 0.1%, 0.1% and 0.2% of the sum of said by-products, said corn or said sweet potato, and said soybean or said double-low rapeseed by weight; and
processing said low-value freshwater fish, said corn or said sweet potato, said soybean or said double-low rapeseed, said vitamin complex, said beef flavor or chicken flavor, and said trace elements via a twin-screw extruder at a first zone temperature of 166-184° C., a second zone temperature of 131-159° C., a third zone temperature of 70-82° C., a pressure of −1.23-2.3 MPa, a screw speed of 30-50 rpm and a feed rate of 4-17 rpm; and
vacuum packaging said by-products, said corn or said sweet potato, said soybean or said double-low rapeseed, said vitamin complex, said beef flavor or chicken flavor, and said trace elements from said twin-screw extruder, and irradiating them at approximately 4 kGy until amount of bacteria is less than 300/g.

8. The method of claim 7, wherein
said first zone temperature is 176° C.;
said second zone temperature is 135° C.; and
said third zone temperature is 76° C.

9. A method of claim 7, wherein said pressure is −1.23 MPa.

10. A method of claim 7, wherein said screw speed is 50 rpm.

11. A method of claim 7, wherein said feed speed is 17 rpm.
